(19) United States
(12) Patent Application Publication
(10) Pub. No.: US 2011/0000741 A1
(43) Pub. Date: Jan. 6, 2011

(54) Process for Audible Acoustic Frequency Management in Gas Flow Systems

(76) Inventors: Ali Berker, Saint Paul, MN (US); Richard W. Greger, Saint Paul, MN (US); Manish Jain, Saint Paul, MN (US); Marie Aloshyna ep Lesuffleur, Minneapolis, MN (US); Smarajit Mitra, West St. Paul, MN (US); Sanat Mohanty, Minneapolis, MN (US)

Correspondence Address: 3M INNOVATIVE PROPERTIES COMPANY, PO BOX 33427, ST. PAUL, MN, 55133-3427, US

(21) Appl. No.: 12/920,339

(22) PCT Filed: Feb. 27, 2009
(86) PCT No.: PCT/US09/35367

§ 371 Date: Aug. 31, 2010

Related U.S. Application Data
(60) Provisional application No. 61/033,198, filed on Mar. 3, 2008.
(60) Provisional application No. 61/033,177, filed on Mar. 3, 2008.

(51) Int. Cl. G10K 11/172

(52) U.S. Cl. 181/296

(57) ABSTRACT

A sound insulation process comprises (a) providing at least one sound barrier comprising at least one composite resonator element; and (b) placing the at least one sound barrier in at least one gas stream that is at least partially enclosed.

### STATEMENT OF PRIORITY

This application claims the priorities of U.S. Provisional Applications Nos. 61/033,198 and 61/033,177, both filed Mar. 3, 2008, the contents of which are hereby incorporated by reference.

### FIELD

This invention relates to processes for attenuating audible noise resulting from gas flow.

### BACKGROUND

Gas flow systems such as air delivery systems in face masks, buildings, and transportation vehicles can be major, unacceptable sources of noise pollution in commercial, industrial, and residential settings. For example, heating, ventilation, and air conditioning (HVAC) systems in buildings and transportation vehicles comprise air-moving devices (such as fans) in combination with pervasive forced air networks or duct systems. The duct systems are used to distribute conditioned air (source air) throughout the building or vehicle and to ventilate or re-circulate return air. The laminar flow of this forced air, the fan noise, the impingement of the air flow against the duct walls (for example, at turns, bends, and corners), and the vibration modes that are set up on the walls of the ducts (typically sheet metal) are primary sources of audible noise in such systems.

To attenuate such noise, traditional sound proofing materials such as absorbers and reflectors (which attenuate through viscous dissipation and reflection, respectively) have been installed in the gas flow path. Such traditional materials are usually active over a broad range of frequencies without providing frequency selective sound control. Active noise cancellation equipment allows for frequency selective sound attenuation, but it is typically most effective in confined spaces and requires an investment in, and operation of, electronic equipment to provide power and control. Although Bragg scattering has been suggested to provide frequency selective sound control in low velocity flow ducts, its potential benefit has appeared to be limited to relatively low transmission losses.

Traditional sound barriers (for example, dense metal sheets or plates) tend to be relatively heavy and air-tight because the sound transmission loss from a material is generally a function of its mass and stiffness. The so-called “mass law” (applicable to many traditional acoustic barrier materials in certain frequency ranges) dictates that as the weight per unit area of a material is doubled, the transmission loss through the material increases by 6 decibels (dB). The weight per unit area can be increased by using denser materials or by increasing the thickness of the barrier. In at least some gas flow applications, added weight can be undesirable, however, and, more importantly, a noise attenuator for use in such applications generally should not significantly block gas flow or produce an excessive gas pressure drop.

Sound absorbers (for example, fibrous or foam materials) have therefore often been used in gas flow systems, as traditional sound-absorbing materials are generally relatively light in weight and relatively porous. Porous sound absorbers can be less attractive for use in certain environments (for example, HVAC ducts), however, because of the resulting potential for moisture entrapment and bacterial growth in the pores of the porous absorber. This can effectively rule out the use of porous absorbers and barriers as liners within such ducts.

In the U.S., vents and ducts are typically externally insulated, but the primary purpose of this is for thermal insulation. A portion of the duct length is often internally lined with sound absorber material for acoustic control, however, and, where appropriate, mechanical sound attenuators or silencers (for example, boxes comprising vanes or baffles and/or dampers) are placed in the duct work. The mechanical attenuators and silencers can be expensive, can cause significant pressure drop, and can increase energy consumption. Low frequency sound (for example, frequencies below about 1000 hertz (Hz)) can be particularly troublesome, as the absorbers and the mechanical attenuators or silencers (and even second lines of defense including building acoustic barriers such as ceiling tiles) are often inadequate in this range.

### SUMMARY

Thus, we recognize that there is a need for processes for managing or controlling noise in gas flow systems that can be at least partially effective in attenuating audible acoustic frequencies (reducing or, preferably, eliminating sound transmission) while preferably utilizing sound barriers that are relatively non-porous (so as to reduce or minimize the likelihood of microbial growth) and/or that do not significantly block gas flow or produce a significant pressure drop. Preferably, the processes can be at least partially effective over a relatively broad range of audible frequencies (preferably, including low frequencies such as those below about 1000 Hz) and/or can be relatively simply and cost-effectively carried out.

Briefly, in one aspect, this invention provides a sound insulation process. The process comprises (a) providing at least one sound barrier comprising at least one composite resonator element (preferably, an array of composite resonator elements); and (b) placing the at least one sound barrier in at least one at least partially enclosed gas stream (preferably, a gas stream in a gas flow duct). The composite resonator element comprises at least one resonator portion and at least one damper portion (preferably, in the form of at least one inner core (as the resonator portion) and at least one outer (relative to the core) shell (as the damper portion, which may or may not be the outermost layer of the composite resonator element)). The resonator portion (or, preferably and hereinafter, the inner core) comprises a first medium having a first density and a first tensile modulus, and the damper portion (or, preferably and hereinafter, the outer shell) comprises a second medium having a second density that is less than the first density and a second tensile modulus that is less than the first tensile modulus. The first medium is an elastic medium having at least one acoustic resonant frequency in the audible range of acoustic frequencies (that is, in the range of 20 hertz (Hz) to 20 kilohertz (kHz)), the elastic medium comprising at least one metal, metal alloy, or a combination thereof, and the second medium is a viscoelastic medium, an elastic medium, or a combination thereof that exhibits acoustic damping of at least one of the acoustic resonant frequencies of the first medium.

Preferably, the second medium is a viscoelastic medium (more preferably, a viscoelastic medium having a speed of propagation of longitudinal sound wave and a speed of propagation of transverse sound wave, the speed of propagation of longitudinal sound wave being at least about 30 times the speed of propagation of transverse sound wave). Preferably, the ratio of the first density to the second density is greater than about two, and/or, preferably, the ratio of the first tensile modulus to the second tensile modulus is in the range of about 1×10³ to about 1×10⁵.

It has been discovered that, by forming a sound barrier comprising one or more of the above-described composite resonator elements and placing it in a gas flow system, effective noise attenuation in the form of band gaps or at least significant audible acoustic transmission losses (for example, greater than 20 decibels (dB)) can be obtained in at least portions of the audible range (that is, the range of 20 hertz (Hz) to 20 kilohertz (kHz)). In the acoustic industry, attenuation on the order of 20+dB is a very significant loss in transmission, approaching 100 percent reduction in acoustic power.

The sound barriers used in the process of the invention provide noise reduction through local resonance (the composite resonator elements being locally resonant structures) and can be, in at least some embodiments, relatively light in weight and relatively small (for example, having external dimensions on the order of a few centimeters or less). By controlling such design parameters as the selection of materials, the core and shell thicknesses, the number of elements, the shapes of the elements, the arrangement of the elements, and so forth, the number and frequencies of the band gap(s) and their widths can be tuned, or, at a minimum, the transmission loss levels can be adjusted as a function of frequency.

The local resonance-based sound barriers can be placed in a gas flow system (for example, so as to extend across at least a portion of the transverse cross-sectional area of the gas stream or flow) to allow only select frequencies to pass through the barrier. The barriers can comprise substantially non-porous materials and can therefore be useful in gas flow systems in which microbial growth is a concern. In addition, the composite resonator element(s) of the barriers can be effective at sufficiently low fill fractions (relative to the transverse cross-sectional area of the gas stream or flow) that gas flow is not significantly blocked or a significant pressure drop induced.

The barriers can generate acoustic band gaps in a passive, yet frequency selective way. Unlike the most common sound absorbers used in the acoustics industry, local resonance-based barriers control sound in transmission mode. Within the range of frequencies of the band gap, there can be essentially no transmission of an incident sound wave through the structure. The band gap is not always absolute (that is, no sound transmission), but, as mentioned above, the sound transmission loss can often be on the order of 20 decibels (dB) or more.

Local resonance-based sound barriers can be placed between a sound source and a receiver to allow only select frequencies to pass through the barrier. The receiver thus hears filtered sound, with undesirable frequencies being blocked. By properly configuring the barrier, the transmitted frequencies can be focused at the receiver, or the undesirable frequencies can be reflected back to the sound source (much like a frequency selective mirror). Unlike current acoustic materials, the local resonance-based sound barriers can be used to actually manage sound waves, rather than simply to attenuate or reflect them.

Thus, in at least some embodiments, the process of the invention can meet the above-cited need for processes for managing or controlling noise in gas flow systems that can be at least partially effective in attenuating audible acoustic frequencies while preferably utilizing sound barriers that are relatively non-porous (so as to minimize the likelihood of microbial growth) and/or that do not significantly block gas flow or produce a significant pressure drop. The process of the invention can be used to provide sound insulation in a variety of different gas flow systems including HVAC systems in buildings (for example, homes, offices, hospitals, and so forth), HVAC systems in transportation vehicles (for example, automobiles, boats, and airplanes), face masks for gas (for example, air) delivery, fan-containing consumer appliances, and the like, and combinations thereof.

### BRIEF DESCRIPTION OF DRAWING

These and other features, aspects, and advantages of the present invention will become better understood with regard to the following description, appended claims, and accompanying drawing, wherein:

FIG. 1 is a perspective view of a composite resonator element that can be used in preparing a sound barrier for use in an embodiment of the process of the invention.

FIG. 2 is a perspective view of a sound barrier, which comprises an array of the composite resonator element(s) of FIG. 1, placed in a gas flow duct in carrying out an embodiment of the process of the invention.

These figures, which are idealized, are not drawn to scale and are intended to be merely illustrative and nonlimiting.

FIG. 3 is a plot of power spectrum (mean squared amplitude in units of volts squared) versus frequency (in units of kHz) for the embodiment of the process of the invention described in Example 1 and for the process described in Comparative Example 1.

### DETAILED DESCRIPTION

### Materials

Materials that are suitable for use as the above-referenced viscoelastic component or medium of the sound barrier used in the process of the invention include viscoelastic solids and liquids. Useful viscoelastic solids and liquids include those having a steady shear plateau modulus (G^{o}_{N}) of less than or equal to about 5×10⁶ Pascals (Pa) at ambient temperatures (for example, about 20° C.), the steady shear plateau modulus preferably extending from about 30 Kelvin degrees to about 100 Kelvin degrees above the glass transition temperature (T_{g}) of the material. Preferably, the viscoelastic material has a steady shear plateau modulus of less than or equal to about 1×10⁶ Pa (more preferably, less than or equal to about 1×10⁵ Pa) at ambient temperatures (for example, about 20° C.). Preferred viscoelastic materials have (preferably, at least in the audible range of acoustic frequencies) a speed of propagation of longitudinal sound wave that is at least about 30 times (preferably, at least about 50 times; more preferably, at least about 75 times; most preferably, at least about 100 times) its speed of propagation of transverse sound wave.

Examples of useful viscoelastic materials include rubbery polymer compositions (for example, comprising lightly-crosslinked or semi-crystalline polymers) in various forms including elastomers (including, for example, thermoplastic elastomers and elastomer foams), elastoviscous liquids, and the like, and combinations thereof (preferably, for at least some applications, elastomers and combinations thereof). Useful elastomers include both homopolymers and copolymers (including block, graft, and random copolymers), both inorganic and organic polymers and combinations thereof, and polymers that are linear or branched, and/or that are in the form of interpenetrating or semi-interpenetrating networks or other complex forms (for example, star polymers). Useful elastoviscous liquids include polymer melts, solutions, and gels (including hydrogels and ionic polymer gels).

Preferred viscoelastic solids include silicone rubbers (preferably, having a durometer hardness of about 20 A to about 70 A; more preferably, about 30 A to about 50 A), epichlorohydrin rubbers (preferably, epichlorohydrin closed cell foams), (meth)acrylate (acrylate and/or methacrylate) polymers (preferably, copolymers of isooctylacrylate (IOA) and acrylic acid (AA)), block copolymers (preferably, comprising styrene, ethylene, and butylene), cellulosic polymers (preferably, cork), blends of organic polymer (preferably, a polyurethane) and polydiorganosiloxane polyamide block copolymer (preferably, a silicone polyoxamide block copolymer), neoprene, and combinations thereof. Preferred viscoelastic liquids include mineral oil-modified block copolymers, hydrogels, ionic polymer gels, and combinations thereof.

Such viscoelastic solids and liquids can be prepared by known methods. Many are commercially available.

Materials that are suitable for use as the above-referenced elastic component(s) or media of the sound barrier used in the process of the invention include essentially all elastic materials. Preferred elastic materials, however, include those having a longitudinal speed of sound that is at least about 2000 meters per second (m/s).

Useful classes of elastic solids include metals (and alloys thereof), inorganic minerals (for example, glass), glassy polymers (for example, cured epoxy resin), and the like, and combinations thereof (including, for example, metal-polymer composites such as a composite of metal powder or metal shavings in a polymeric binder matrix). Preferred classes of elastic solids include metals, metal alloys, glassy polymers, and combinations thereof (more preferably, copper, aluminum, epoxy resin, copper alloys, aluminum alloys, and combinations thereof even more preferably, copper, aluminum, copper alloys, aluminum alloys, and combinations thereof). For use in an outer shell (where glassy polymers and the relatively lighter metals and metal alloys can be preferred), aluminum, aluminum alloys, and combinations thereof can be more preferred (and aluminum most preferred). For use in an inner core (where the relatively heavier metals and metal alloys can be preferred), copper, copper alloys, and combinations thereof can be even more preferred (and copper most preferred).

Such elastic materials can be prepared or obtained by known methods. Many are commercially available.

If desired, the sound barrier used in the process of the invention can optionally comprise other component materials. For example, the sound barrier can include more than one viscoelastic material and/or more than one of the above-described elastic materials. Conventional additive materials can be included in the media (for example, antioxidants can be present to enhance polymer stability at relatively high temperatures), provided that the desired acoustical characteristics of the media are not unacceptably impacted.

Preparation of Sound Barrier

The sound barrier used in the sound insulation process of the invention comprises at least one composite resonator element comprising at least one inner core and at least one outer shell. The inner core (resonator) preferably can be in at least partial contact (more preferably, at least partial direct contact) with the outer shell (damper). The inner core comprises a first medium having a first density and a first tensile modulus, and the outer shell comprises a second medium having a second density that is less than the first density and a second tensile modulus that is less than the first tensile modulus.

The first medium is an elastic medium having at least one acoustic resonant frequency in the audible range of acoustic frequencies (that is, frequencies in the range of 20 hertz (Hz) to 20 kilohertz (kHz)), the elastic medium comprising at least one metal, metal alloy, or a combination thereof, and the second medium is a viscoelastic medium, an elastic medium, or a combination thereof that exhibits acoustic damping of at least one of the acoustic resonant frequencies of the first medium.

Preferably, the second medium is a viscoelastic medium (more preferably, a viscoelastic medium having a speed of propagation of longitudinal sound wave and a speed of propagation of transverse sound wave, the speed of propagation of longitudinal sound wave being at least about 30 times the speed of propagation of transverse sound wave). Preferably, the ratio of the first density to the second density is greater than about two (more preferably, greater than about 8), and/or, preferably, the ratio of the first tensile modulus to the second tensile modulus is in the range of about 1×10³ to about 1×10⁵ (more preferably, about 1×10⁴ to about 1×10⁵).

In forming the composite resonator elements, the materials for the inner core and the outer shell can be selected from the above-described viscoelastic and elastic materials in accordance with the above-described resonance, damping, density, and tensile modulus characteristics. This can provide local resonance structures comprising a denser, inner core, which can exhibit acoustic resonance that can be damped by the less dense, outer shell. The composite resonator element(s) can be formed, for example, by using at least one elastic, metal-containing material as the inner, resonator medium (first medium) and at least one viscoelastic material, at least one elastic material, or a combination thereof (preferably, at least one viscoelastic material) as the outer, damping medium (second medium). The core and/or the shell can further comprise other materials, provided that the resonance and damping characteristics imparted by the first and second media, respectively, are maintained. For example, the core can comprise minor amounts of viscoelastic or other non-elastic material.

The exposed surfaces of the composite resonator element(s) are preferably substantially smooth and/or non-porous (for example, having surface feature and/or pore diameters less than or equal to about one micron in size), so as to reduce or minimize the likelihood of microbial growth. The exposed surfaces preferably comprise material having a density greater than or equal to about 1 gram per cubic centimeter. Thus, the exposed surfaces preferably comprise, consist, or consist essentially of material(s) other than a traditional foam or fibrous absorber material (or, if such a porous material is used as the outermost layer of the element(s), at least the exposed surface of the material is treated in a manner such as sealing or glazing or the like, so as to reduce surface roughness and/or porosity).

Certain material selections can also enhance the antimicrobial characteristics of the element(s). For example, copper can be selected for its inherent antimicrobial properties and used as the outermost layer of the element(s) in forming certain annular concentric coaxial cylinder structures described below.

Preferably, the sound barrier used in the process of the invention comprises an array (a two-dimensional or three-dimensional array or a combination thereof) of more than one composite resonator element (a plurality thereof). The array can be substantially periodic, non-periodic, or a combination thereof (preferably, substantially periodic). The composite resonator elements of the array can be substantially identical or can vary in shape, size, thickness and/or composition of shell and/or core, and so forth, within the array. The number (and size) of the composite resonator elements in the array can vary widely, depending, for example, upon factors such as the transverse cross-sectional area of the gas flow in a particular gas flow system and/or the desirability of filtering out certain acoustic frequencies.

The shapes or configurations of the composite resonator element(s) can also vary widely and include geometrical solids (for example, spheres, rectangular solids, cylindrical solids, triangular solids, other closed polygonal solids, and so forth), annular structures (for example, an inner pipe or rod within an outer pipe), and the like (preferably, spheres, circular cylinders, circular cylindrical annular structures, and combinations thereof; more preferably, circular cylinders, circular cylindrical annular structures, and combinations thereof; most preferably, circular cylinders). If desired, aerodynamic shapes (for example, airfoils and the like), which can assist in minimizing gas pressure drops in the gas flow system, can be utilized.

The composite resonator element(s) can be solid or can be hollow (preferably, solid). Preferably, the inner core of the element(s) is substantially solid (for example, the inner core can be a non-porous solid, a porous solid, a particulate solid comprising an interstitial material such as air or epoxy resin, or a combination thereof). The shell can be continuous or discontinuous but is preferably substantially continuous.

The dimensions of the composite resonator element(s) (for example, heights and transverse cross-sectional areas) can vary widely (for example, ranging from on the order of millimeters to as large as a meter or more), depending upon the spatial and/or acoustical requirements of a particular gas flow application. The thicknesses of the outer shell and the inner core of the element(s) can also vary, but generally the shell can be less than or equal to the core thickness. If desired, the element(s) can comprise a multi-layer core and/or a multi-layer shell (for example, in the form of concentric annular structures), provided that the resonance and damping features of the core and shell, respectively, are not significantly altered.

The element(s) can optionally comprise more than one core and/or more than one shell, which can be evenly or unevenly spaced, of the same or different compositions, and of the same or different thicknesses, and so forth. For example, a useful structure is an annular concentric coaxial cylinder structure comprising alternating core (resonator) and shell (damper) layers. In multi-core and/or multi-shell composite resonator elements, the number of cores can be less than, equal to, or greater than the number of shells in the element, and, thus, the element can have a core (resonator) layer as the outermost layer of the element or a shell (damper) “layer” or portion as the innermost portion of the element.

The composite resonator element(s) can be individually or collectively attached to a gas flow system by any known or hereafter-developed method or manner of attachment or placement. Preferably, however, the sound barrier further comprises an intervening attachment, placement, and/or containment component (for example, a frame comprising a damper, a slider, a spacer, or the like, or a combination thereof) that can effectively decouple the barrier from the vibrations of the gas flow system (for example, the vibrations of a gas flow duct into which the barrier is inserted).

The resulting sound barrier can be a macroscopic construction (for example, having a size scale on the order of centimeters or less). If desired, the barrier can take the form of a spatially periodic lattice with uniformly-sized and uniformly-shaped composite resonator elements at its lattice sites, surrounded by a gas matrix (for example, air). Design parameters for such structures include the type of lattice (for example, square, triangular, and so forth), the spacing between the lattice sites (the lattice constant), the make-up and shape of the unit cell (for example, the fractional area of the unit cell that is occupied by the elements—also known as f, the so-called “fill factor”), the physical properties of the materials utilized (for example, density, Poisson ratio, moduli, and so forth), the shape of the composite resonator elements (for example, rod, sphere, hollow rod, square pillar, and so forth), and the like. By controlling such design parameters, the frequency of the resulting band gap, the number of gaps, and their widths can be tuned, or, at a minimum, the level of transmission loss can be adjusted as a function of frequency.

Preferred arrays include those having a fill factor in the range of about 0.1 to about 0.65 or higher (more preferably, about 0.2 to about 0.6; most preferably, about 0.3 to about 0.55). Preferred types of lattices include those that are relatively “open” (for example, rather than those having staggered rows of elements), so as to minimize any gas pressure drop due to the presence of the sound barrier. Thus, preferred lattices include those other than triangular (more preferably, square lattices, rectangular lattices, and combinations thereof).

Preferably, the sound barrier is a two- or three-dimensional array (more preferably, a two-dimensional array) in the form of cylindrical elements in a square lattice pattern surrounded by a gas matrix. The cylindrical elements are more preferably circular cylindrical elements, most preferably comprising a core having a density of at least about 8 grams per cubic centimeter and a shell having a density of less than or equal to about 1.5 grams per cubic centimeter.

The total number of composite resonator elements of such sound barriers can range, for example, from as few as two to as high as hundreds or more. Dimensions of the elements can also vary widely (depending upon, for example, the gas stream size and/or the desired acoustic frequencies to be filtered out) but are preferably on the order of centimeters or less. Such dimensions and numbers of elements can provide sound barriers having dimensions on the order of centimeters or less. If desired, the cores of the elements can be cleaned (for example, using surfactant compositions or isopropanol) prior to addition of the shells, and/or one or more bonding agents (for example, adhesives or mechanical fasteners) can optionally be utilized (provided that there is no significant interference with the desired acoustics).

A preferred sound barrier comprises from 1 to about 4 rows (more preferably, from 1 to 3 rows; most preferably, 1 or 2 rows) of two or more composite resonator elements, which can span at least a portion of the transverse cross-sectional area of the gas stream. (Generally, the smallest numbers of rows and/or columns that can provide the desired acoustical effect for a particular application can be preferred, so as to minimize any resulting gas pressure drop due to the presence of the sound barrier.) The composite resonator elements comprise an outer shell (which may or may not be the outermost layer of the element) of viscoelastic material (preferably, silicone rubber, acrylate polymer, or a combination thereof) and an inner core of elastic material (preferably, copper, copper alloy, or a combination thereof), with the shell having a thickness that is from about 0.1 to about 0.5 the thickness (for cylindrical elements, the radius) of the core.

The sound barrier used in the process of the invention can optionally further comprise one or more conventional or hereafter-developed sound insulators (for example, conventional absorbers, conventional barriers, phononic crystals, and the like, and combinations thereof; preferably, phononic crystals) and/or can further comprise one or more components that address other aspects of gas flow (for example, filtration, thermal management, and so forth). If desired, such conventional sound insulators can be layered, for example, to broaden the frequency effectiveness range of the sound barrier.

### Use of Sound Barrier

The above-described sound barriers can be used in carrying out the sound insulation process of the invention by placing one or more of the sound barriers in an at least partially enclosed gas stream in a gas flow system (preferably, in a gas flow duct). Such gas flow systems include HVAC duct systems in buildings and transportation vehicles, exhaust lines, and the like. Preferably, the sound barrier can be placed in the gas stream in a manner such that the barrier spans at least a portion of the transverse cross-sectional area of the gas stream.

In general terms, such usage can include interposing or placing the sound barrier between an acoustic source (preferably, a source of audible acoustic frequencies) and an acoustic receiver (preferably, a receiver of audible acoustic frequencies). Common acoustic sources in gas flow systems include noises due to gas flow, fan noises, and the like (preferably, noises or other sounds having an audible component; more preferably, noises or other sounds having a frequency component in the range of about 250 Hz to about 10,000 Hz). The acoustic receiver can be, for example, a human ear, any of various recording devices, and the like (preferably, the human ear).

The above-described sound barriers can be particularly effective in addressing annoying discrete frequencies in gas flow systems, as local resonance-based barriers tend to have narrower band gaps than those exhibited by phononic crystals. If desired, however, the barriers can be used in combination with one or more phononic crystals to provide broader filtering action.

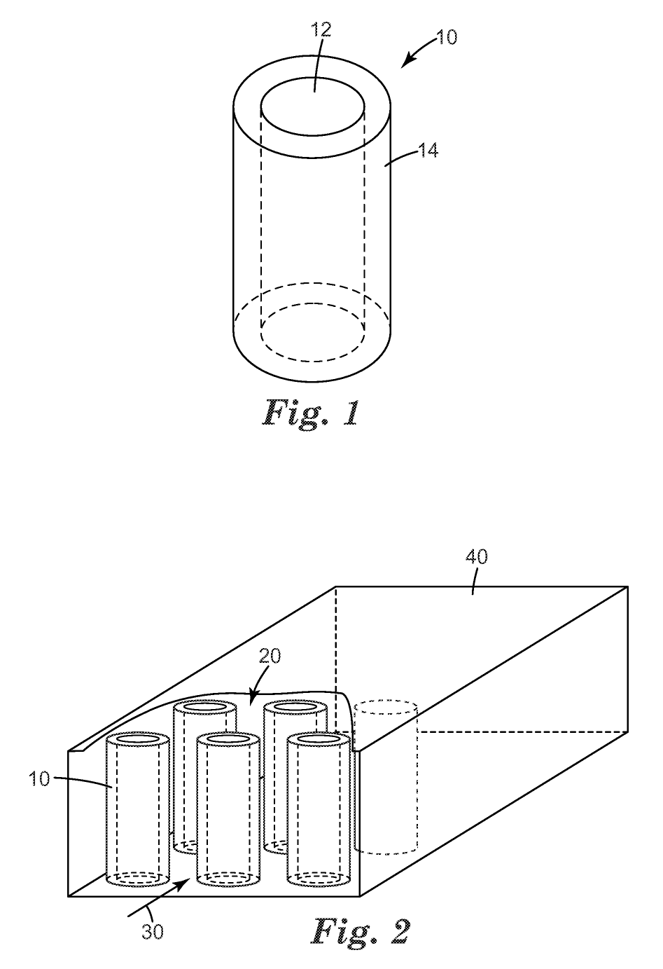

The process of the invention can be carried out by placing one or more of the sound barriers in essentially any appropriate locations in the gas stream of the gas flow system. For example, referring to FIGS. 1 and 2, in an embodiment of the process of the invention sound barrier 20 (shown in FIG. 2) comprising an array of composite resonator elements 10 (shown in FIG. 1) comprising core 12 and shell 14 is placed in gas stream 30 flowing through gas duct 40 (shown in FIG. 2). The sound barrier can preferably be placed relatively close to the acoustic source of the gas flow system (for example, relatively close to a furnace of an HVAC system), so as to reduce the need for multiple sound barriers in the gas flow system.

The process of the invention can be used to achieve transmission loss across a relatively large portion of the audible range (with preferred embodiments providing a transmission loss that is greater than or equal to about 20 dB across the range of about 800 Hz to about 10,000 Hz; with more preferred embodiments providing a transmission loss that is greater than or equal to about 20 dB across the range of about 500 Hz to about 10,000 Hz; with even more preferred embodiments providing a transmission loss that is greater than or equal to about 20 dB across the range of about 250 Hz to about 10,000 Hz; and with most preferred embodiments providing substantially total transmission loss across at least a portion of the range of about 500 Hz to about 10,000 Hz). Such transmission losses can be achieved without the use of porous absorber materials and/or without significant gas pressure drops (for example, less than about 25 percent; preferably, less than about 10 percent).

Due to the use of the above-described local resonance-based sound barriers, the process of the invention can be particularly effective in achieving transmission losses of at least about 20 dB in the generally troublesome, low frequency range of about 250 Hz to about 1500 Hz without the need for relatively large sound barrier dimensions. For example, such transmission losses can be achieved while maintaining sound barrier dimensions on the order of centimeters or less (preferably, less than or equal to about 10 cm).

### EXAMPLES

Objects and advantages of this invention are further illustrated by the following examples, but the particular materials and amounts thereof recited in these examples, as well as other conditions and details, should not be construed to unduly limit this invention. All parts, percentages, ratios, and the like in the examples are by weight, unless noted otherwise. Solvents and other reagents were obtained from Sigma-Aldrich Chemical Company, St. Louis, Mo. unless otherwise noted.

### Materials

Epoxy: 3M™ Scotch-Weld™ Epoxy Potting Compound/Adhesive DP270 Clear, a two-part epoxy/amine resin system, available from 3M Company, St. Paul, Minn.

Solid Copper Rods: Item Number 8966K41, Alloy 110 Electronic-Grade Copper, diameter 3.175 mm (⅛ inch), available from McMaster-Carr Inc., Elmhurst, Ill.

Silicone Rubber: Sylgard™ 184 Silicone Elastomer Kit, a two-part kit comprising dimethylsiloxane-based liquid silicone elastomer base and liquid silicone resin solution curing agent, available from Dow Corning Corporation, Midland, Mich.

### Example 1 and Comparative Example 1

Two sound barriers, each comprising an array of elements in an epoxy matrix, were constructed to evaluate the effect of an oscillator-damper component (composite resonator elements) and to simulate the process of the invention. The first sound barrier consisted of seven (7) rows of eleven (11) circular cylindrical solid copper rods (described above) in an epoxy matrix (Comparative Example 1, having no oscillator-damper component). The second sound barrier was substantially identical to the first, except that it had a circular cylindrical annulus of silicone rubber (0.8 mm thickness) placed between each copper rod and the epoxy matrix (Example 1, having an oscillator-damper component in the form of composite resonator elements). The silicone rubber annulus was prepared by mixing the elastomer base of the above-described silicone rubber with its curing agent in a 1 to 10 ratio by rotation on a roller mixer for 1 hour. The resulting material was applied to the copper rods by knife coating, and the resulting coated rods were placed in an oven (Despatch Model LFD1-42-3, available from Despatch Industries LP, Minneapolis, Minn.) at 90° C. for 3 minutes and 45 seconds.

The sound barriers were constructed by using two fluoropolymer molds (made of polytetrafluoroethylene (PTFE), available from Plastics International, Eden Prairie, Minn.), each consisting of a base (having drilled on its face seven (7) rows of eleven (11) cylindrical blind holes or wells, each having a diameter of 3.2 mm and a depth of 6 mm) and four (4) side walls attached to the base by screws. Uncoated copper rods were inserted into the blind holes of one mold, and the silicone-coated copper rods were inserted into the blind holes of the other mold. Epoxy (described above) was dispensed to fill the remaining space inside the molds by using a dispenser gun. The resulting filled molds were left at room temperature (about 23° C.) for 48 hours. Then, the walls were removed from the bases, and the resulting sound barriers were placed in the above-described oven at 80° C. for 1 hour.

In both sound barriers, the copper rods were arranged in a square lattice pattern having a lattice parameter, a, equal to 7.72 mm. The sound barriers had fill factors, f, of 0.132 (Comparative Example 1) and 0.300 (Example 1), respectively, with both having overall dimensions of 55 mm×86 mm×86 mm (width×length×height) and being supported on a 55 mm×86 mm×10 mm (width×length×height) fluoropolymer base.

Acoustic transmission loss measurements were carried out for each of the sound barriers. The measurements were carried out in a pulser/receiver device equipped with ultrasonic transducers, which was set up to measure power spectra (square of the amplitude (magnitude) of the Fourier transform of a time signal). In this device, transmitter and receiver wave transducers (longitudinal wave, 0.5 MHz, Panametrics-NDT Model V101, available from Olympus NDT Inc., Waltham, Mass.) were connected to a pulser/receiver (Model 5077PR Ultrasonic Pulser/Receiver, Olympus NDT Inc., Waltham, Mass.), which was connected to an Agilent 6000 A oscilloscope (available from Agilent Technologies, Inc., Palo Alto, Calif.). LabView™ data acquisition software (available from National Instruments Corporation, Austin, Tex.) was used to acquire data from the oscilloscope.

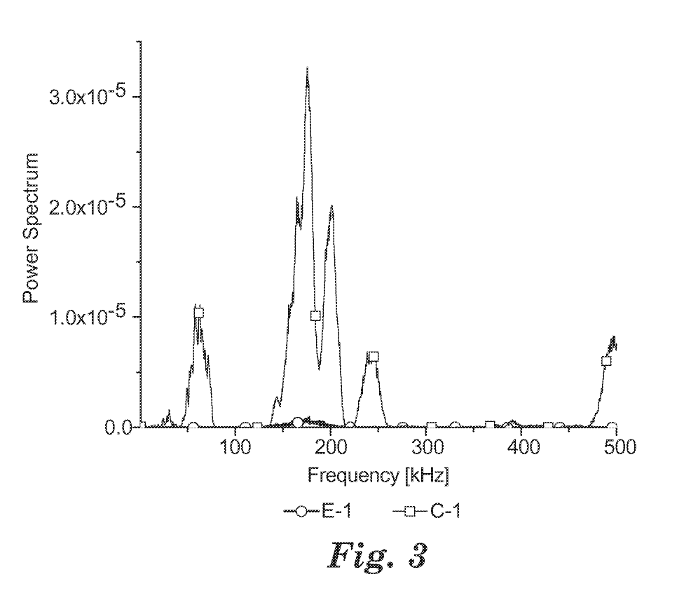

In carrying out the measurements, each sound barrier was placed between and in contact with the two transducers. Petroleum jelly (white, Catalog No. VW3339-2, VWR International Company, West Chester, Pa.) was used to ensure a good connection at both contact surfaces. Power spectra (amplitude squared versus frequency) were obtained by fast Fourier transform (FFT) of the temporal signal (amplitude versus time) acquired from the oscilloscope by the software. FIG. 3 shows the results obtained over the entire audible frequency range and into the ultrasound range. The additional noise reduction (transmission loss) due to damping ranged from 0 to greater than 20 dB, depending upon the frequency.

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only, with the scope of the invention intended to be limited only by the claims set forth herein as follows:

1. A process comprising (a) providing at least one sound barrier comprising at least one composite resonator element, said composite resonator element comprising at least one resonator portion and at least one damper portion, said resonator portion comprising a first medium having a first density and a first tensile modulus, and said damper portion comprising a second medium having a second density that is less than said first density and a second tensile modulus that is less than said first tensile modulus, said first medium being an elastic medium having at least one acoustic resonant frequency in the audible range of acoustic frequencies, said elastic medium comprising at least one metal, metal alloy, or a combination thereof, and said second medium being a viscoelastic medium, an elastic medium, or a combination thereof that exhibits acoustic damping of at least one of said acoustic resonant frequencies of said first medium; and (b) placing said at least one sound barrier in at least one gas stream that is at least partially enclosed.

2. The process of claim 1, wherein said sound barrier comprises an array of said composite resonator elements.

3. The process of claim 2, wherein said array is a two-dimensional array, a three-dimensional array, or a combination thereof; and/or wherein said array has a fill factor in the range of 0.1 to 0.65.

4. (canceled)

5. The process of claim 1, wherein the ratio of said first density to said second density is greater than two; and/or wherein the ratio of said first tensile modulus to said second tensile modulus is in the range of 1×10³ to 1×10⁵.

6. (canceled)

7. The process of claim 1, wherein said acoustic resonant frequency is in the range of 20 hertz to 20 kilohertz.

8. The process of claim 1, wherein said second medium is a viscoelastic medium.

9. The process of claim 8, wherein said viscoelastic medium has a speed of propagation of longitudinal sound wave that is at least 30 times its speed of propagation of transverse sound wave at least in the audible range of acoustic frequencies; and/or wherein said viscoelastic medium is selected from viscoelastic solids, viscoelastic liquids, and combinations thereof.

10. (canceled)

11. The process of claim 9, wherein said viscoelastic solids and viscoelastic liquids have a steady shear plateau modulus of less than or equal to 5×10⁶ Pa at 20° C.; and/or wherein said viscoelastic solids and said viscoelastic liquids are selected from rubbery polymer compositions and combinations thereof.

12. (canceled)

13. The process of claim 11, wherein said rubbery polymer compositions are selected from elastomers, elastoviscous liquids, and combinations thereof.

14. The process of claim 1, wherein said second medium is an elastic medium.

15. The process of claim 1, wherein each said elastic medium has a speed of propagation of longitudinal sound wave that is at least 2000 meters per second.

16. The process of claim 14, wherein said elastic medium is an elastic solid selected from metals, metal alloys, inorganic minerals, glassy polymers, and combinations thereof.

17. The process of claim 1, wherein said composite resonator element has a configuration selected from spheres, circular cylinders, circular cylindrical annular structures, and combinations thereof.

18. The process of claim 1, wherein said resonator portion is in the form of at least one inner core and said damper portion is in the form of at least one outer shell.

19. The process of claim 1, wherein said composite resonator elements have exposed surfaces that comprise a material other than a foam or fibrous material.

20. The process of claim 1, wherein said at least partially enclosed gas stream is in a gas flow duct.

21. The process of claim 1, wherein said process provides a transmission loss that is greater than or equal to 20 dB across the range of 800 Hz to 10,000 Hz; and/or wherein said process provides a transmission loss of at least 20 dB across the range of 250 Hz to 1500 Hz and said sound barrier has all dimensions less than or equal to 10 cm in size.

22. (canceled)

23. The process of claim 1, wherein said sound barrier further comprises at least one phononic crystal.

24. A process comprising (a) providing at least one sound barrier comprising a two-dimensional or three-dimensional array of cylindrical composite resonator elements in a square lattice pattern surrounded by a gas matrix, said composite resonator elements comprising at least one inner core and at least one outer shell, said inner core comprising a first medium having a first density and a first tensile modulus, and said outer shell comprising a second medium having a second density that is less than said first density and a second tensile modulus that is less than said first tensile modulus, said first medium being an elastic medium having at least one acoustic resonant frequency in the audible range of acoustic frequencies, said elastic medium comprising at least one metal, metal alloy, or a combination thereof, and said second medium being a viscoelastic medium, an elastic medium, or a combination thereof that exhibits acoustic damping of at least one of said acoustic resonant frequencies of said first medium; and (b) placing said at least one sound barrier in at least one gas stream in at least one gas flow duct.

25. The process of claim 24, wherein said array is a two-dimensional array, said cylindrical composite resonator elements are circular cylindrical composite resonator elements, said inner core has a density of at least 8 grams per cubic centimeter, said outer shell has a density of less than or equal to 1.5 grams per cubic centimeter, said circular cylindrical composite resonator elements have exposed surfaces that comprise a material other than a foam or fibrous material, and said gas flow duct is part of an HVAC system in a building, an HVAC system in a transportation vehicle, a face mask for gas delivery, a fan-containing consumer appliance, or a combination thereof.
